(19) United States
(12) Patent Application Publication
(10) Pub. No.: US 2024/0088529 A1
(43) Pub. Date: Mar. 14, 2024

(54) BONDING METHOD, BONDING STRUCTURE, AND BATTERY

(71) Applicant: PRIMEARTH EV ENERGY CO., LTD., Kosai-shi (JP)

(72) Inventor: Shigeki SAITO, Hamamatsu-shi (JP)

(73) Assignee: PRIMEARTH EV ENERGY CO., LTD., Kosai-shi (JP)

(21) Appl. No.: 18/244,669

(22) Filed: Sep. 11, 2023

(30) Foreign Application Priority Data
Sep. 14, 2022 (JP) 2022-146255

(51) Int. Cl. H01M 50/536; B23K 20/10

(52) U.S. Cl. CPC H01M 50/536; B23K 20/10

(57) ABSTRACT

A method for bonding a current collector to an electrode body is provided. The electrode body includes electrode plate end portions arranged over each other in a thickness direction. The method includes forming a covering by integrally covering the electrode plate end portions with resin at a bonding position of the current collector, and bonding a bonding portion of the current collector, by performing solid-phase bonding, to edges of the electrode plate end portions integrated by the formed covering.

### BACKGROUND

### 1. Field

The following description relates to a bonding method, a bonding structure, and a battery.

### 2. Description of Related Art

A battery such as a lithium ion rechargeable battery includes an electrode body formed by a stack of positive and negative electrodes with separators arranged in between. The electrode body is connected to an external terminal by a current collector, serving as a connection member, when the electrode body is accommodated in a case.

More specifically, each electrode of the electrode body includes electrode plate end portions stacked in an overlapping manner in the thickness direction. Each electrode plate end portion has an uncoated portion that is not coated with an electrode active material. Further, the electrode plate end portions are arranged in the thickness direction at the ends of the electrode body in accordance with positive or negative polarity. The current collector of the positive electrode or the negative electrode is often bonded to a foil group bundling the electrode plate end portions of the corresponding polarity.

However, with such a foil group structure, the applied tension load increases at electrode plate end portions that are farther from the foil grouping. As a result, such a tension load may break the electrode plate end portions, that is, foil tearing or the like. The uncoated portion where plastic deformation tends to occur may be formed over a wide area to reduce tension load caused by foil grouping. This will, however, reduce the area of the electrode plate coated with an electrode active material, that is, the area in which an electrode active material layer is formed so that the electrode functions effectively.

Japanese Patent Application Laid-Open No. 2006-32112 discloses a structure that bonds a bonding surface of a current collector to the edges of electrode plate end portions including uncoated portions and does not group the electrode plate end portions. Japanese Patent Application Laid-Open No. 2006-32112 also discloses that the edges of the electrode plate end portions are bent to be substantially L-shaped to increase the bonding area of the current collector.

However, the electrode plate end portions are usually extremely thin foils. Thus, in the bonding structures described above, when the current collector is bonded, the electrode plate end portions arranged in the thickness direction of the electrode body may be deformed in an irregular manner Thus, a uniform bonding state cannot be easily ensured.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for bonding a current collector to an electrode body is provided. The electrode body includes electrode plate end portions arranged over each other in a thickness direction. The method includes forming a covering by integrally covering the electrode plate end portions with resin at a bonding position of the current collector, and bonding a bonding portion of the current collector, by performing solid-phase bonding, to edges of the electrode plate end portions integrated by the formed covering.

The method may further include exposing the edges of the electrode plate end portions from the covering by partially removing the resin.

The method may further include bending the edges of the electrode plate end portions exposed from the covering.

In the method, the solid-phase bonding may be performed through complex vibration bonding or electromagnetic pressure welding.

In the method, the resin may include a photocurable resin.

In another general aspect, a bonding structure bonding a current collector to an electrode body including electrode plate end portions arranged over each other in a thickness direction is provided. The bonding structure includes a resin covering integrally covering the electrode plate end portions at a bonding position of the current collector, and a bonding portion of the current collector bonded to edges of the electrode plate end portions exposed from the covering.

In the bonding structure, the edges of the electrode plate end portions may be bonded to the bonding portion in a bent state.

In another general aspect, a battery including the above bonding structure is provided.

Other features and aspects will be apparent from the following detailed description, the drawings, and the claims.

### BRIEF DESCRIPTION OF THE DRAWINGS

FIG. 1 is a perspective view of a rechargeable battery.

FIG. 2 is an exploded view of an electrode body.

FIG. 3 is a side view of the rechargeable battery.

FIG. 4 is a side view of an electrode body and a current collector.

FIG. 5 is a side view of the electrode body and the current collector.

FIG. 6 is a plan view showing a bonding position of the current collector bonded to the electrode body.

FIG. 7 is a side view of the electrode body including a covering that covers and integrally fixes electrode plate end portions arranged in a thickness direction at an axial end.

FIG. 8 is a cross-sectional view of a covering formed from resin and electrode plate end portions covered by the covering.

FIG. 9 is a flowchart showing a procedure for forming a covering.

FIG. 10 is a diagram illustrating a solid-phase bonding process when a current collector is bonded to edges of the electrode plate end portions integrated with the covering.

FIG. 11 is a diagram illustrating complex vibration bonding.

FIG. 12 is a diagram illustrating electromagnetic pressure welding.

FIG. 13 is a diagram illustrating electromagnetic pressure welding.

FIG. 14 is a cross-sectional view of the current collector bonded to the edges of the electrode plate end portions integrated with the covering.

FIG. 15 is a cross-sectional view of the covering and the electrode plate end portions according to a modified example.

FIG. 16 is a cross-sectional view of the covering and the electrode plate end portions according to a modified example.

FIG. 17 is a cross-sectional view showing a method for bonding according to a modified example in which resin forming the covering is partially removed to expose the edges of the electrode plate end portions.

FIG. 18 is a cross-sectional view showing a method for bonding according to a modified example in which the edges of the electrode plate end portions exposed from the covering are bent.

FIG. 19 is a cross-sectional view showing a bonding structure according to a modified example in which the current collector is bonded to the edges of the bent electrode plate end portions.

FIG. 20 is a side view of the electrode body according to a modified example showing a bonding position of the current collector bonded to the electrode plate end portions.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A method for bonding a current collector and a bonding structure according to an embodiment will now be described with reference to the drawings.

Rechargeable Battery

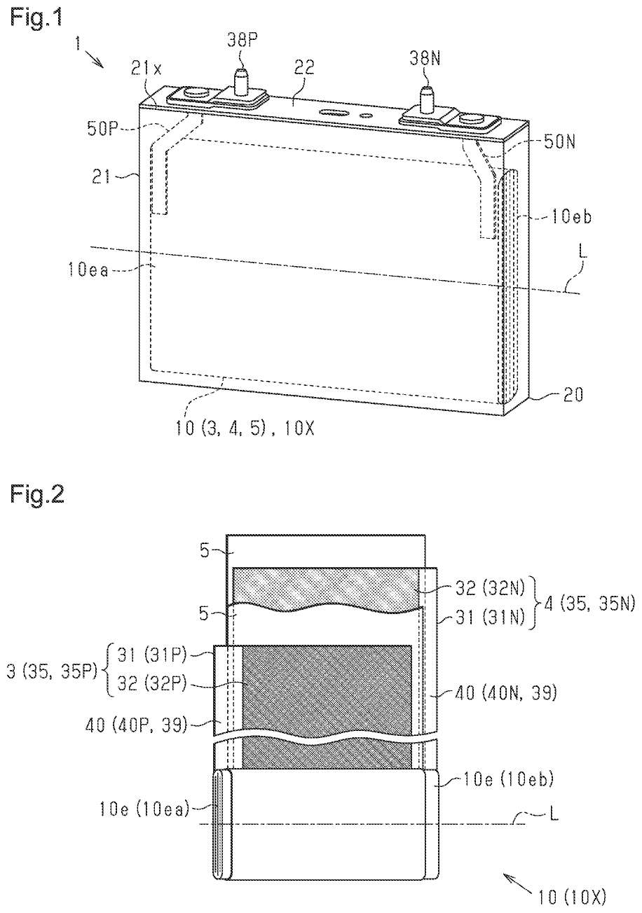

As shown in FIG. 1, a rechargeable battery 1 includes an electrode body 10, which integrates a positive electrode 3, a negative electrode 4, and separators 5, and a case 20 that accommodates the electrode body 10. In the rechargeable battery 1 of the present embodiment, the electrode body 10 in the case 20 is impregnated with a non-aqueous electrolyte (not shown).

Specifically, the rechargeable battery 1 of the present embodiment includes sheets of the positive electrode 3, the negative electrode 4, and the separator 5. The electrode body 10 of the present embodiment is formed by rolling a stack of the positive electrode 3, the negative electrode 4, and the separators 5, which are arranged between the positive electrode 3 and the negative electrode 4. Thus, the electrode body 10 of the present embodiment is a roll 10X in which the electrodes and the separators 5 are arranged in the radial direction.

The case 20 of the present embodiment includes a substantially flattened and box-shaped case body 21 and a lid member 22 that closes an open end 21x of the case body 21. In the rechargeable battery 1 of the present embodiment, the roll 10X serving as the electrode body 10 has the shape of a flattened roll in conformance with the box-shaped case 20.

Electrode Sheet and Electrode Body

As shown in FIG. 2, in the rechargeable battery 1 of the present embodiment, the positive electrode 3 and the negative electrode 4 each include an electrode sheet 35. The electrode sheet 35 includes an electrode plate 31 having a sheet-like shape and an electrode active material layer 32 stacked on the electrode plate 31.

Specifically, an electrode sheet 35P of the positive electrode 3 includes an electrode plate 31P formed from aluminum or the like. The electrode plate 31P is coated with a mixture paste containing a lithium-transition metal oxide serving as a positive electrode active material. Further, an electrode sheet 35N of the negative electrode 4 includes an electrode plate 31N formed from copper or the like. The electrode plate 31N is coated with a mixture paste containing a carbon-based material serving as a negative electrode active material. The mixture pastes each contain a binder. In the rechargeable battery 1 of the present embodiment, the mixture pastes are dried to form a positive electrode active material layer 32P and a negative electrode active material layer 32N on the corresponding positive and negative electrode sheets 35P, 35N.

Further, in the rechargeable battery 1 of the present embodiment, the positive and negative electrode sheets 35P, 35N each have the form of a strip. In the electrode body 10 of the present embodiment, the stack of the positive and negative electrode sheets 35P, 35N and the separators 5 arranged in between is rolled about a rolling axis L that extends in the width direction of the strip (lateral direction in FIG. 2).

In FIG. 2, the separators 5 and the electrode sheets 35 are rolled with the electrode sheet 35P of the positive electrode 3 located at the inner side. FIG. 2 shows one example of the structure of the electrode body 10, and the separators 5 and the electrode sheets 35 may be rolled so that the electrode sheet 35N of the negative electrode 4 is located at the inner side. This determines whether the electrode sheet 35 at the outermost side of the electrode body 10 is the electrode sheet 35P of the positive electrode 3 or the electrode sheet 35N of the negative electrode 4.

External Terminal and Connection Member

As shown in FIGS. 1 to 3, the lid member 22 of the case 20 includes a positive electrode terminal 38P and a negative electrode terminal 38N projecting outward from the case 20 as external terminals 38 of the rechargeable battery 1. Further, the electrode sheets 35 each include an uncoated portion 39 in which the electrode plate 31 is free from the electrode active material layer 32. Specifically, in the electrode sheets 35 of the present embodiment, the strips of the electrode plates 31P, 31N, coated with the mixture pastes containing electrode-active materials, each have an end in the width direction. That is, an electrode plate end portion 40P of the positive electrode 3 and an electrode plate end portion 40N of the negative electrode 4 each define an uncoated portion 39. In the rechargeable battery 1 of the present embodiment, the electrode sheet 35P of the positive electrode 3 is electrically connected to the positive electrode terminal 38P by the uncoated portion 39, and the electrode sheet 35N of the negative electrode 4 is electrically connected to the negative electrode terminal 38N by the uncoated portion 39.

More specifically, as shown in FIG. 2, when rolling the electrode sheets 35 and the separators 5, the electrode body 10 of the present embodiment includes the electrode plate end portion 40P of the positive electrode 3 as the uncoated portion 39 at a first axial end 10ea (left end in FIG. 2). The electrode body 10 includes an electrode plate end portion 40N of the negative electrode 4 as the uncoated portion 39 at a second axial end 10eb (right end in FIG. 2). That is, the rolled electrode body 10 includes the electrode plate end portion 40P of the electrode sheet 35P and the electrode plate end portion 40N of the electrode sheet 35N projecting outward at opposite sides in the rolling axis direction.

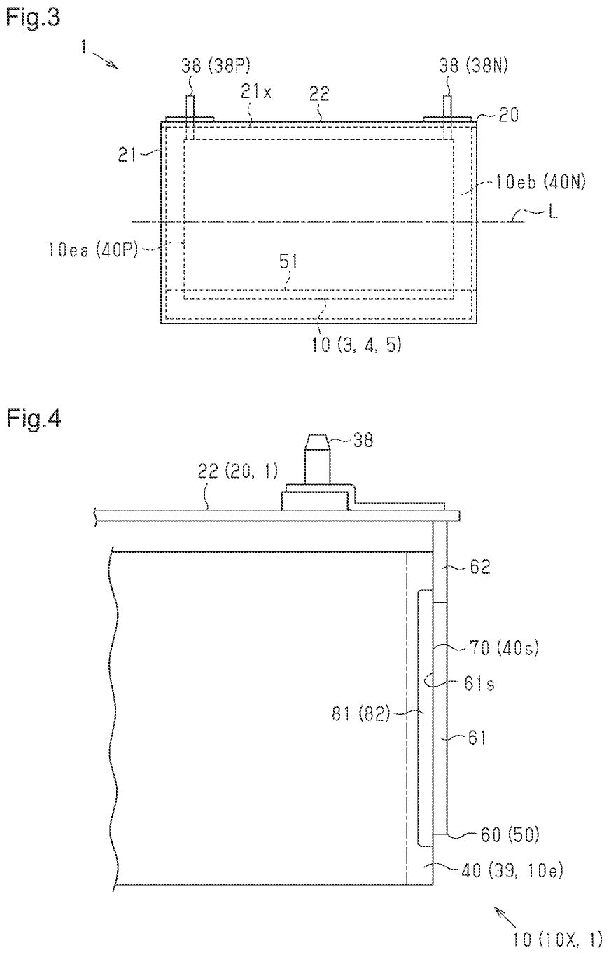

Further, as shown in FIGS. 1 and 3, when the electrode body 10 of the present embodiment is accommodated in the case 20, the rolling axis L of the electrode body 10 extends in the longitudinal direction (lateral direction in FIG. 3) of the lid member 22 having the form of a substantially rectangular plate. In the rechargeable battery 1 of the present embodiment, in this state, the electrode plate end portion 40P of the positive electrode 3 is connected to the positive electrode terminal 38P by a connecting member 50P, and the electrode plate end portion 40N of the negative electrode 4 is connected to the negative electrode terminal 38N by a connecting member 50N.

Furthermore, in the rechargeable battery 1 of the present embodiment, a fluorine-based electrolyte 51 is injected into the case 20 when the electrode body 10 is accommodated in the case 20 as described above. The electrolyte 51 is prepared by dissolving lithium salt serving as supporting salt in an organic solvent. Thus, in the rechargeable battery 1 of the present embodiment, the electrode body 10 accommodated in the case 20 includes the electrolyte 51.

Current Collector

A current collector bonded to the electrode body 10 in the rechargeable battery 1 of the present embodiment forms a connection member for an external terminal.

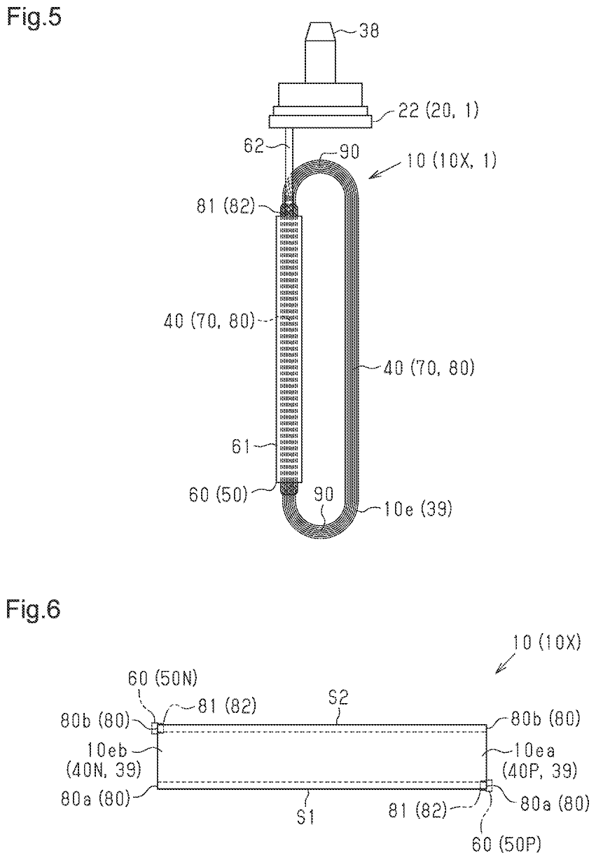

As shown in FIGS. 4 and 5, the electrode body 10 of the present embodiment is formed into the roll 10X so that the electrode plate end portions 40 of the positive electrode 3 are stacked in an overlapping manner in the thickness direction at one axial end 10e of the electrode body 10, and the electrode plate end portions 40 of the negative electrode 4 are stacked in an overlapping manner in the thickness direction at the other axial end 10e of the electrode body 10. In other words, since the electrode body 10 is formed into the roll 10X, the electrode plate end portions 40 of the positive electrode 3 include the electrode plate end portions 40 that are stacked in an overlapping manner in the thickness direction at one axial end 10ea of the electrode body 10, and the electrode plate end portions 40 of the negative electrode 4 include the electrode plate end portions 40 that are stacked in an overlapping manner in the thickness direction at the other axial end 10eb of the electrode body 10. Further, the rechargeable battery 1 of the present embodiment includes current collectors 60 that are bonded to the axial ends 10e of the electrode body 10. As described above, the positive and negative electrode plate end portions 40 arranged at the axial ends 10e of the electrode body 10 each include the uncoated portion 39 in which the electrode plate 31 is free from the active material layer 32 (see FIG. 2). Thus, in the rechargeable battery 1 of the present embodiment, the current collectors 60 are used as positive and negative connection members 50 so that the positive electrode 3 and the negative electrode 4 of the electrode body 10 are electrically connected to the positive and negative external terminals 38. In other words, the positive electrode current collector 60 is used as the positive connection member 50 to electrically connect the positive electrode 3 to the positive electrode external terminal 38, and the negative electrode current collector 60 is used as the negative connection member 50 to electrically connect the negative electrode 4 to the negative electrode external terminal 38.

Specifically, each current collector 60 of the present embodiment includes a bonding portion 61 bonded to an axial end 10e of the electrode body 10 and an extending portion 62 continuous with the bonding portion 61. In the current collector 60 of the present embodiment, the bonding portion 61 and the extending portion 62 have the form of a plate elongated in the direction in which an edge 70 of the electrode plate end portion 40 extends (vertical direction in each drawing) at the axial end 10e of the electrode body 10. That is, the bonding portion 61 of the current collector 60 of the present embodiment is bonded to the edge 70 of each electrode plate end portion 40, which is located at an axial end 10e of the electrode body 10. Furthermore, in the current collector 60 of the present embodiment, the extending portion 62 extending from one end of the bonding portion 61 in the longitudinal direction of the bonding portion 61 is connected to the external terminal 38 arranged on the lid member 22. In the current collector of the present embodiment, the bonding portion 61 is wider than the extending portion 62. In the rechargeable battery 1 of the present embodiment, each current collector 60 serves as a positive or negative connection member 50 in accordance with the polarity of the electrode plate end portion 40 bonded to the corresponding bonding portion 61.

Arrangement of Current Collector

As shown in FIG. 6, the electrode body 10 of the present embodiment formed into the roll 10X includes first and second axial ends 10ea, 10eb where the electrode plate end portions 40P, 40N, which have different polarities are located. The electrode body 10 has the form of a flattened roll and includes first and second flattened surfaces S1, S2 at opposite sides. Further, the first axial end 10ea of the first flattened surface S1 includes a long side 80a bonded to the current collector 60. The second axial end 10eb of the second flattened surface S2 includes a long side 80b bonded to the current collector 60.

Bonding Structure and Method for Bonding Current Collector

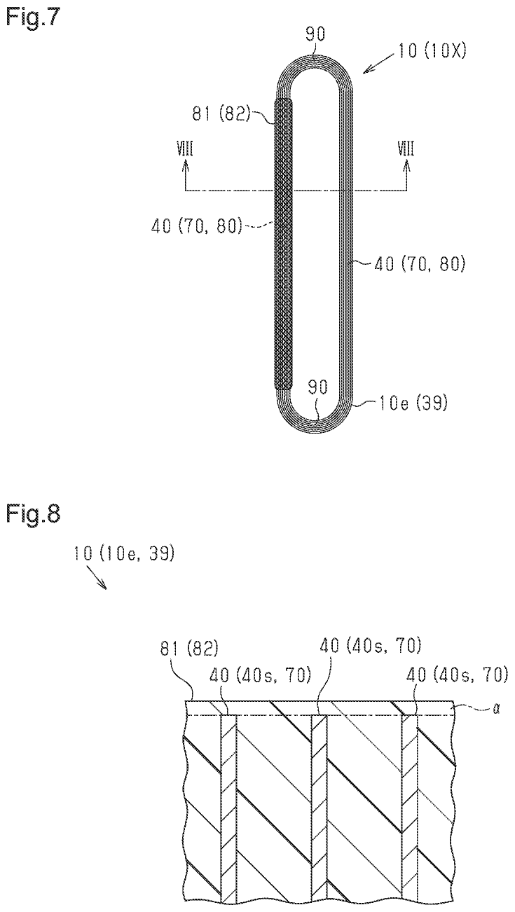

As shown in FIGS. 5 to 8, the electrode body 10 of the present embodiment includes a covering 81 that integrally covers the electrode plate end portions 40 located at a bonding position where the current collector 60 is bonded to the axial end 10e of the electrode body 10. That is, in the electrode body 10 of the present embodiment, the covering 81 is arranged on one of the long sides 80 bonded to a corresponding one of the positive and negative current collectors 60. In the rechargeable battery 1 of the present embodiment, the bonding portion 61 of the current collector 60 is bonded to the edges 70 of the electrode plate end portions 40 integrated with the covering 81.

Specifically, as shown in FIG. 8, the covering 81 of the present embodiment is formed from resin. In the rechargeable battery 1 of the present embodiment, the covering 81 is formed from a photocurable resin 82.

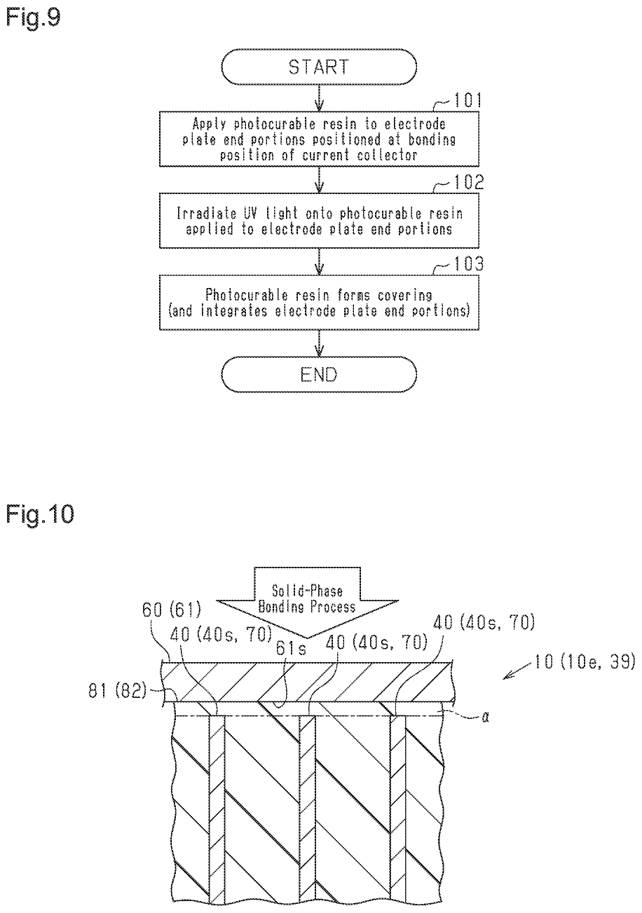

Specifically, as shown in FIG. 9, in the electrode body 10 of the present embodiment, first, the photocurable resin 82 in liquid form is applied to the electrode plate end portions 40 located at the bonding position of the current collector 60 (step S101). The photocurable resin 82 may be, for example, an acrylic or epoxy photocurable resin. Next, the photocurable resin 82 applied to the electrode plate end portions 40 is irradiated with ultraviolet light (step S102, UV irradiation). The photocurable resin 82 cured by the UV irradiation forms the covering 81. In the electrode body 10 of the present embodiment, the electrode plate end portions 40 located at the bonding position of the current collector 60 are integrated with the formed covering 81 (step S103).

Further, as shown in FIG. 10, in the electrode body 10 of the present embodiment, the bonding portion 61 of the current collector 60 is coupled to the covering 81 in the axial direction of the electrode body 10, that is, the direction that the end surfaces 40s of the electrode plate end portions 40 covered by the covering 81 face (from above in FIG. 10). From this state, the bonding portion 61 of the current collector 60 of the present embodiment is bonded to the electrode plate end portions 40 through a solid-phase bonding process.

Specifically, as shown in FIG. 11, the solid-phase bonding process for the current collector 60 bonded to the electrode plate end portions 40 may be, for example, complex vibration bonding. Complex vibration bonding is a type of ultrasonic bonding and may be referred to as ultrasonic complex vibration bonding and differs from the typical ultrasonic bonding in that a bonding tool 83 vibrates the bonding portion 61 of the current collector 60 while moving in an arcuate path. Further, the vibration path of the bonding tool 83 allows for bonding with reduced amplitude. This reduces heat generation when bonding the bonding portion 61 of the current collector 60 to the edges 70 of the electrode plate end portions 40 and avoids thermal degradation such as deterioration of the electrode active material caused by heat and formation of scattered matter usually referred to as sputter.

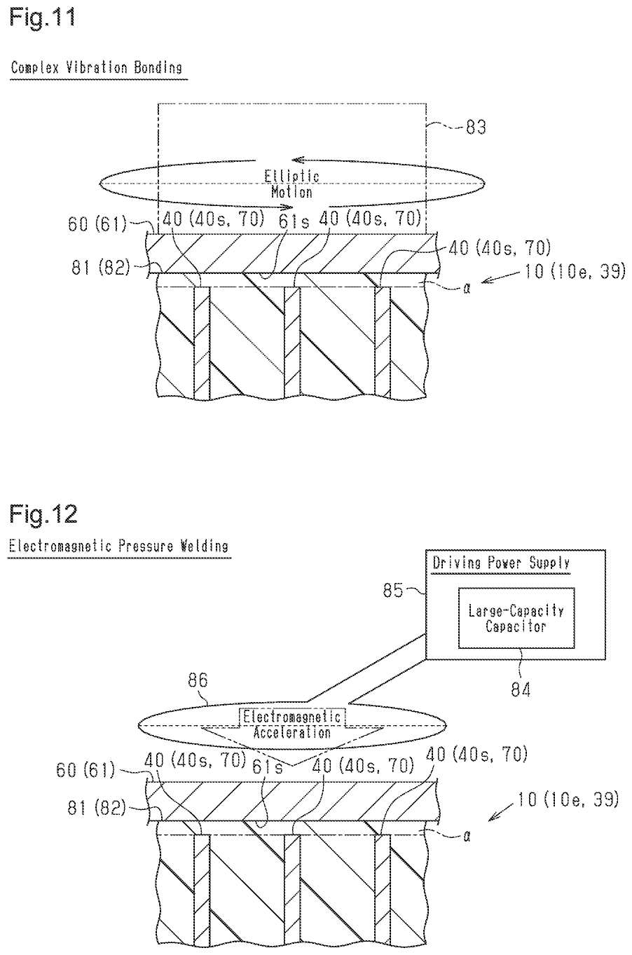

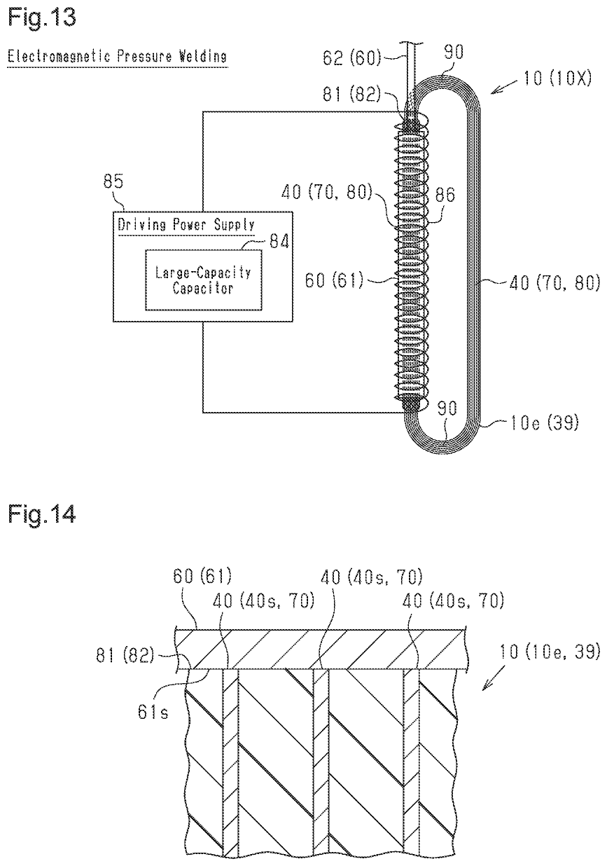

Further, as shown in FIGS. 12 and 13, the solid-phase bonding process for the current collector 60 bonded to the electrode plate end portions 40 stacked in an overlapping manner in the thickness direction may be, for example, electromagnetic pressure welding. That is, the electromagnetic pressure welding is a method for pressure-welding materials using electromagnetic force and may be referred to as electromagnetic seam welding. Specifically, a driving power supply 85 including a large-capacity capacitor 84 is used to instantaneously energize an acceleration coil 86 with a large current. This generates electromagnetic force to accelerate the bonding portion 61 of the current collector 60 so that the bonding portion 61 of the current collector 60 is pressure-welded to the edge 70 of each electrode plate end portion 40.

Further, the electromagnetic pressure welding generates a relatively small amount of heat when the bonding portion 61 of the current collector 60 is instantaneously bonded to the edge 70 of each electrode plate end portion 40. This reduces thermal degradation and formation of scattered matter in the same manner as the complex vibration bonding described above.

Further, as shown in FIGS. 8, 10, and 11, in the electrode body 10 of the present embodiment, the covering 81 is formed to integrally cover the edges 70 of the electrode plate end portions 40, located at the bonding position of the current collector 60, including the end surfaces 40s of the electrode plate end portions 40 stacked in an overlapping manner in the thickness direction. Further, an excessive covering region a formed on the covering 81 is removed during a bonding step when complex vibration bonding or electromagnetic pressure welding is used in the solid-phase bonding process. Specifically, resin in the excessive coating region a is forced into gaps between the electrode plate end portions 40 by vibration during the complex vibration bonding or by electromagnetic acceleration during the electromagnetic pressure welding.

As shown in FIG. 14, in the rechargeable battery 1 of the present embodiment, the bonding portion 61 of the current collector 60 is bonded to the edge 70 of each electrode plate end portion 40 exposed from the covering 81, specifically, the end surface 40s of each electrode plate end portion 40.

Operation

The covering 81 covers the edges 70 of the electrode plate end portions 40. This integrates and reinforces the edges 70 of the electrode plate end portions 40. Since the bonding portion 61 of the current collector 60 is bonded to the edges 70 of the electrode plate end portions 40 in this state. the edges of the electrode plate end portions 40 stacked in an overlapping manner in the thickness direction will not become separated. Thus, the electrode plate end portions 40 will remain arranged in a regular manner in a stable and uniform bonding state. In addition, when the solid-phase bonding process is performed in the bonding step, the generation of heat will be limited.

The advantages of the present embodiment will now be described.

(1) The rechargeable battery 1 includes the current collector 60 bonded to the axial end 10e of the electrode body 10 where the electrode plate end portions 40 are located and stacked in an overlapping manner in the thickness direction. The current collector 60 is bonded by performing a step of integrally covering the electrode plate end portions 40 with resin at the bonding position of the current collector 60 and a step of bonding the bonding portion 61 of the current collector 60, through solid-phase bonding, to the edges 70 of the electrode plate end portions 40 integrated with the covering 81 formed from the resin.

With the above configuration, the edges 70 of the electrode plate end portions 40 arranged over each other in the thickness direction do not become separated when bonded. Thus, the edges of the electrode plate end portions 40 will not become arranged in an irregular manner, thereby ensuring a uniform bonding state of the current collector 60 bonded to the edges 70 of the electrode plate end portions 40. This allows the current collector 60 to be bonded to the electrode plate end portions 40 at any position.

Further, the solid-phase bonding is used to reduce heat generation during the bonding process and avoid thermal degradation such as deterioration of the electrode active material that would be caused by heat. Further, the formation of scattered matter usually referred to as spatter is avoided. This allows the current collector 60 to be bonded to the electrode plate end portions 40 in a preferred manner.

(2) Solid-phase bonding is complex vibration bonding or electromagnetic pressure welding.

Solid-phase bonding process is performed during the bonding process to effectively reduce heat generation during bonding and avoid thermal degradation and the formation of scattered matter. Further, even when the excessive covering region α is formed, in which the edges 70 of the electrode plate end portions 40 including the end surfaces 40s of the electrode plate end portions 40 stacked in an overlapping manner in the thickness direction are located in the covering 81, the excess covering region α is removed during the solid-phase bonding process. This allows the current collector 60 to be bonded to the edge 70 of each electrode plate end portion 40 in an easier and more stable manner.

(3) The photocurable resin 82 is used to form the covering 81 that covers and integrally fixes the edges 70 of the electrode plate end portions 40 stacked in an overlapping manner in the thickness direction. The covering 81 can be formed easily and stably. In addition, the covering 81 is formed within a relatively short period.

The above-described embodiment may be modified as follows. The above-described embodiment and the following modification can be combined if the combined modifications remain technically consistent with each other.

In the above embodiment, the solid-phase bonding used to bond the current collector 60 to the electrode plate end portions 40 stacked in an overlapping manner in the thickness direction is complex vibration bonding or electromagnetic pressure welding. Instead, any other solid-phase bonding process such as general ultrasonic bonding may be used if the bonding process can be performed in a solid-phase state without causing an excessive temperature rise.

In the above embodiment, the excessive covering region α is formed, in which the edges 70 of the electrode plate end portions 40 including the end surfaces 40s of the electrode plate end portions 40 stacked in an overlapping manner in the thickness direction are located in the covering 81. Instead, the covering 81 may be formed so that the edge 70 of each electrode plate end portion 40 is exposed in advance.

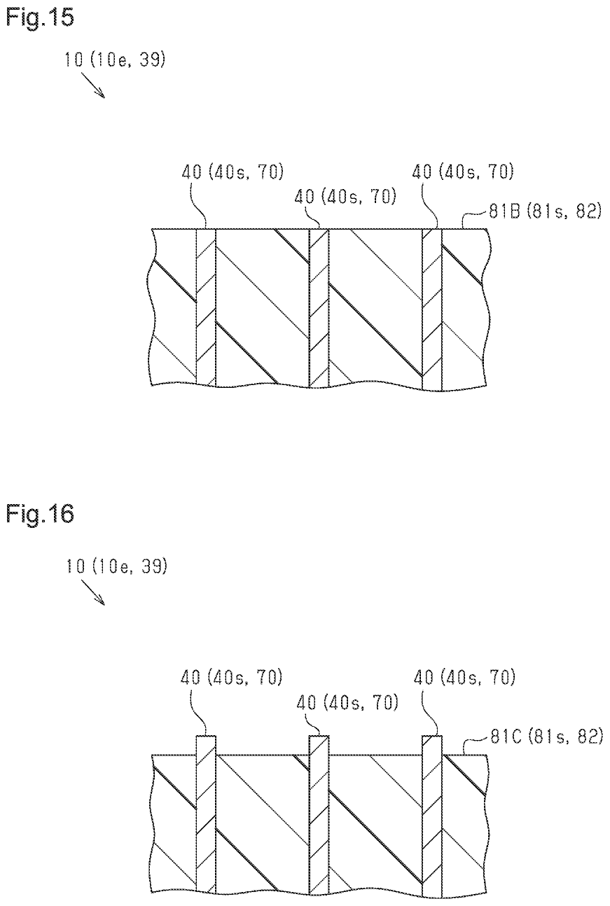

For example, as shown in FIG. 15, a covering 81B may be formed so that the end surfaces 40s of the electrode plate end portions 40 stacked in an overlapping manner in the thickness direction are flush with a surface 81s of the covering 81B.

Further, as shown in FIG. 16, a covering 81C may be formed so that the end surface 40s of each electrode plate end portion 40 projects from a surface 81s of the covering 81C.

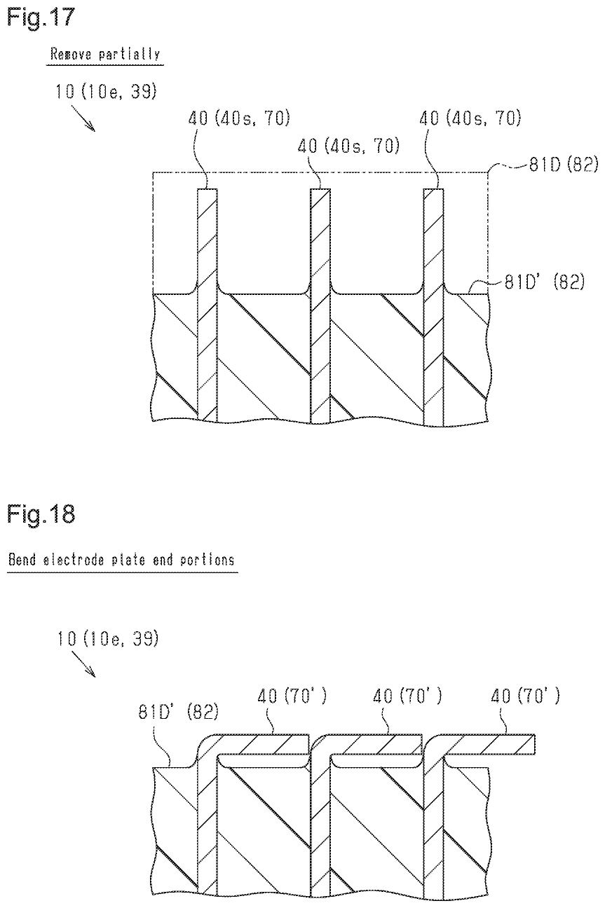

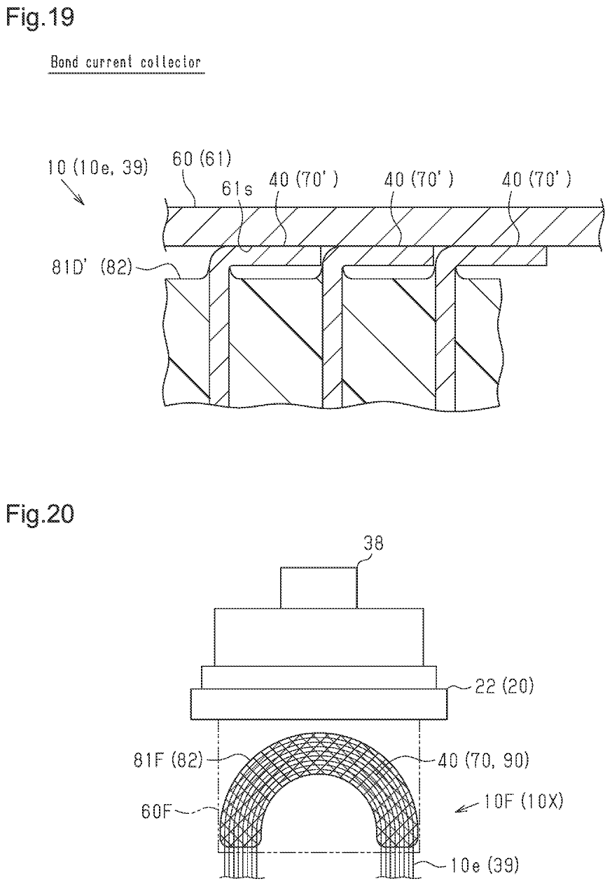

Further, as shown in FIGS. 17 to 19, after a covering 81D is formed, the resin forming the covering 81D is partially removed. A step of removing the resin shown in FIG. 17 is performed through, for example, laser ablation using, for example, a UV pulse laser or the like. Further, after the removing step, the edge 70 of each electrode plate end portion 40 exposed from a covering 81D′ is bent. In a step of bending each electrode plate end portion 40 shown in FIG. 18, the electrode plate end portion 40 may be uniformly bent into a substantially L-shape using a jig or the like. As shown in FIG. 19, the bonding portion 61 of the current collector 60 may be bonded to an edge 70′ of each bent electrode plate end portion 40.

In other words, the current collector 60 can be easily bonded to the edge 70 of each electrode plate end portion 40 by partially removing the resin and exposing the edge 70 of each electrode plate end portion 40 from the covering 81D′. Further, by bending the edge 70 of each electrode plate end portions 40 exposed from the covering 81D′ into a substantially L-shape, bonding can be performed more easily, and a uniform bonding state can be ensured. This allows the current collector 60 to be bonded to each electrode plate end portion 40 in a preferred manner.

In the above embodiment, the current collector 60 is bonded to the edge 70 of each electrode plate end portion 40 located at the long side 80 of the flattened roll at the axial end 10e of the electrode body 10. Instead, the bonding position of the current collector 60 bonded to the electrode body 10 may be set in any manner.

For example, in an electrode body 10F of a modified example shown in FIG. 20, a covering 81F is formed at a curved portion 90 having the shape of a roll. A current collector 60F may be bonded, through solid-phase bonding, to the edges 70 of the electrode plate end portions 40 integrated with the covering 81F.

In the embodiment described above, the photocurable resin 82 is used to form the covering 81. Instead, any resin may be used to form the covering 81 if the electrode plate end portions 40 stacked in an overlapping manner in the thickness direction can be covered and integrated, that is, if the electrode plate end portions 40 are integrally fixed. The photocurable resin 82 easily forms the covering 81 in a shorter time.

In the above modified example, a UV pulse laser or the like is used in the resin removing step. Alternatively, for example, infrared light having a wavelength of 1 μm or greater may be used. The resin removing step may use a method other than laser ablation.

In the above embodiment, the current collector 60 includes the bonding portion 61 having an elongated and substantially flat shape extending in the direction in which the edges 70 of the electrode plate end portions 40 stacked in an overlapping manner in the thickness direction extend at the axial end 10e of the electrode body 10. Instead, the current collector 60 may be shaped in any manner. However, it is desirable that the bonding portion 61 of the current collector 60 have a flat bonding surface 61s to ensure a uniform bonding state and stably bond the current collector 60 to the edges 70 of the electrode plate end portions 40.

The above embodiment is implemented in the electrode body 10 of the rechargeable battery 1 when the positive and negative electrode sheets 35P, 35N holding the separators 5 therebetween are stacked and rolled. Instead, the embodiment may be implemented when, for example, the current collector 60 is bonded to the electrode body 10 that is a non-rolled stack.

In the above embodiment, the method for bonding the current collector is applied to a method for manufacturing the rechargeable battery 1 configured as a lithium ion rechargeable battery. Instead, the method for bonding the current collector may be applied to other batteries.

The external terminal does not need to be shaped as shown in the drawings such as FIGS. 1 and 20 and may be shaped in any manner. The shape of the case 20 forming the shell of the rechargeable battery 1 does not need to be flattened and box-shaped and may be changed into, for example, a cylindrical shape or the like in any manner.

Technical ideas obtainable from the above embodiments will now be described below as clauses.

### [Clause 1]

A rechargeable battery (1), including:
an electrode body (10) including an electrode plate (31), the electrode plate including electrode plate end portions (40) stacked and spaced apart in a thickness direction of the electrode plate at an end (10e) of the electrode body;
a non-aqueous electrolyte (51);
a case (20) that accommodates the electrode body and the non-aqueous electrolyte;
a current collector (60) bonded to edges of the electrode plate end portions at the end of the electrode body; and
a resin (82) filling gaps between the electrode plate end portions in a region (61) where the current collector is bonded to the electrode plate end portions, the resin supporting the electrode plate end portions.

### [Clause 2]

The rechargeable battery according to clause 1, where the electrode plate has the form of a strip and is rolled about a rolling axis (L), and the electrode body includes an end that is an end in a rolling axis direction.

### [Clause 3]

The rechargeable battery according to clause 1, where
the electrode plate is one of multiple electrode plates,
the electrode body is a stack of the electrode plates, and
an end of the electrode body is an end edge of the stack.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for bonding a current collector to an electrode body, the electrode body including electrode plate end portions arranged over each other in a thickness direction, the method comprising:
forming a covering by integrally covering the electrode plate end portions with resin at a bonding position of the current collector; and
bonding a bonding portion of the current collector, by performing solid-phase bonding, to edges of the electrode plate end portions integrated by the formed covering.

2. The method according to claim 1, further comprising:
exposing the edges of the electrode plate end portions from the covering by partially removing the resin.

3. The method according to claim 2, further comprising:
bending the edges of the electrode plate end portions exposed from the covering.

4. The method according to claim 1, wherein the solid-phase bonding is performed through complex vibration bonding or electromagnetic pressure welding.

5. The method according to claim 1, wherein the resin includes a photocurable resin.

6. A bonding structure bonding a current collector to an electrode body including electrode plate end portions arranged over each other in a thickness direction, the bonding structure comprising:
a resin covering integrally covering the electrode plate end portions at a bonding position of the current collector; and
a bonding portion of the current collector bonded to edges of the electrode plate end portions exposed from the covering.

7. The bonding structure according to claim 6, wherein the edges of the electrode plate end portions are bonded to the bonding portion in a bent state.

8. A battery, comprising:
the bonding structure according to claim 6.
